(19) United States
(12) Patent Application Publication
(10) Pub. No.: US 2014/0098276 A1
(43) Pub. Date: Apr. 10, 2014

(54) CT Optic distortion filter

(71) Applicant: Calvin J. Thompson, Glenwood Landing, NY (US)

(72) Inventor: Calvin J. Thompson, Glenwood Landing, NY (US)

(21) Appl. No.: 13/815,051

(22) Filed: Jan. 28, 2013

Related U.S. Application Data
(60) Provisional application No. 61/633,355, filed on Feb. 9, 2012.

(51) Int. Cl. G02B 26/08; G03B 15/00

(52) U.S. Cl. CPC G02B 26/08; G02B 26/0816; G02B 26/0875; G03B 15/00
USPC 348/335; 359/290

(57) ABSTRACT

The present invention creates distorted images for use in video, film, photos, mobile devices, video games, morphing targets, interactive screens, or any device with a display screen. The main components are a frame with provision for mechanical manipulation, with a reflective surface affixed to it, video or film source, projector, receiving surface, camera and computer. A video is projected onto a reflective surface that has been manipulated by the introduction of mechanical movement and/or heat so as to create changes in the reflective surface, causing visual distortions. The reflection is then recorded by a device such as a camera and/or a three dimensional scanner. While the description of the invention enables one of ordinary skill in the art to make and use what is disclosed, it should not be limited by the above described but by all embodiments and methods within the scope and spirit of the invention as claimed.

### CROSS-REFERENCE TO RELATED APPLICATIONS

Provisional Application Ser. No.: 61/633,355

### TECHNICAL FIELD

The present invention relates generally to the creation of visual special effects by way of reflective surfaces, optics and their implementation.

### BACKGROUND OF THE INVENTION

Currently there is a need for creating visual special effects in video displays for use in various applications and to personalize the viewing environment where images can be viewed. Visual special effects are currently created for viewing on computers, televisions, mobile devices, image carrying devices, image projections or on interactive devices and displays. As changing technology aids the development of visual special effects it enables new video effects to be created in an economic way but frequently reduces the ability for creativity because the techniques and processes for creating such effects is reduced and limited by the choices of the creators and programmers of such technological solutions.

The present invention provides a method and apparatus for creating and modifying moving or still images for use in consumer and professional applications. The method and apparatus described herein uses the physical properties of reflective surfaces, filters and optics and laser engraving devices as a basis for providing greater creative potential, greater flexibility and stability and therefore better individual choice and control in image modification.

### BREIF SUMMARY OF THE INVENTION

The present invention relates to methods and apparatus for creating and recording visual special effects for use in film, video, and in electronic devices and for use in a variety of ways in entertainment products, on the Internet, and in electronic devices.

### DETAILED DESCRIPTION OF THE INVENTION

The present invention identifies and uses the qualities of manipulated and movable reflective surfaces and filters and the physical spacing of such elements such that the spacing between such elements (“the negative spacing”), becomes a factor in the creation of the special effects which are the goal of the present invention. One may find new uses when combining and capturing the phenomena of distorted reflections with a projected moving image on a reflective surface and which is then recorded or when a distorted reflection is alternatively projected directly into a recording device. These unique characteristics provide for unlimited customization and artistic personalization as compared to the solutions offered by prepackaged computerized solutions.

The present invention provides for the physical manipulation of reflected surfaces by way of heating, the use air currents and direct physical manipulation to create a unique image quality that creates better abstractions of the image. The physical manipulation of the reflective surfaces and projected upon surfaces can be further accomplished by the use of a dynamic frame, a device upon which a reflective or projection surface is affixed which provides for the physical manipulation of a reflective or projection surface either by manual manipulation or by way of the use of programmable mechanical actuators thereby providing for the repetition of the desired movement and the resulting visual effect caused by the reflection or projection. In addition, the use of a dynamic frame also provides for the alteration of the focal plane of the image being reflected or projected upon the surface disposed upon the dynamic frame. The present invention further provides for the manipulation of images by way of the use of pyrographic modification using lasers to engrave the reflective and/or projection surfaces during the image recordation and/or capture process.

The dynamic frame manipulation of the image is an improvement over prior art which merely provides for a static frame. The present invention is an improvement over the prior art as disclosed in U.S. Patent Registration Ser. No.: 4243315, DEVICE FOR SELECTIVELY DISTORTED REFLECTED IMAGES AND THE METHOD OF PERFORMING SAME. In addition, the prior art disclosed in U.S. Patent Application Ser. No.: 20100162133, entitled USER INTERFACE PARADIGM FOR NEXT-GENERATION MOBIEL MESSAGING teaches the creation of a three dimensional illusion providing for the perception of three dimensions due to the modified pixel shape. The present invention discloses the use of a computer to provide for the processing of an image for display on the screen of a computerized device, television, mobile device, any display, or as a standalone effect, which displays can be of a multiplicity of shapes, and may also have novel features such as a changing shape, blinking appearance and other characteristics not provided for or otherwise taught in the prior art. Conventional technology relies almost exclusively on computerization and digitization and thereby fails to provide for the ability of the user to customize the creation of the display environment in the manner disclosed by the present invention.

The present invention is an improvement upon the invention disclosed in U.S. Patent Registration Ser. No.: 4243315, DEVICE FOR SELECTIVELY DISTORTED REFLECTED IMAGES AND THE METHOD OF PERFORMING SAME by providing for the use of a physically manipulated frame holding a projection surface or reflective surface and for further providing for the direct recordation of an image directly into a recording device and for providing for the use of the thermal manipulation of surfaces so as to provide for a multiplicity of options for creativity in the creation and manipulation of images when creating visual special effects.

The present invention, the C T OPTIC DISTORTION FILTER, creates distorted, animated, compressed and expanded images using still photos, video, film by way of direct image projection and reflection and direct recordation of the projected images into a recording device. The unique way of producing the optics and the unique frame that holds the reflection or projection surfaces are a novel element in the present invention. The reflective and projection surfaces can be made of optical grade polymer, plastics, polycarbonates, glass, and shrink wrap type polymers and cast resins. One skilled in such arts can readily imagine other surfaces or materials that could be employed to provide for such visual effects.

The present invention provides for the use of a dynamic frame upon which the reflective or projection surface can be placed and/or stretched and/or mounted. In one embodiment of the present invention the reflective and/or projection surface can be physically manipulated by hand or by way of the use of motorized mechanisms such as computer controlled actuators so as to provide for the distortion of the reflective and/or projection surface. In another embodiment of the present invention the reflective and/or projection surface can be treated with heat either by a radiant source or a device that provides for the application of heated forced air thereby causing modifications and distortions to the reflective and/or projection surface.

The dynamic frame has multiple effects on the image. One of the effects of the dynamic frame is the ability to adjust the focus and/or to distort the image reflected in or projected upon the surface affixed to the dynamic frame. Another effect that can be achieved by the use of the dynamic frame is that an optically neutral or negative space or blank space can be created in the image area when a partial non-reflective surface is used on the reflective and/or projection surface affixed to the dynamic frame. A third effect is the dynamic frame can change the image dimension in a dynamic way if a flexible frame material is chosen. A fourth effect can be achieved by way of using a three dimensional reflective or projection surface in front of the reflective and/or projection surface disposed on the dynamic frame. It should be obvious to one of ordinary skill in the arts related to the creation of visual effects that there are multiple surfaces, frames, and ways of adjusting, manipulating and altering such devices so as to provide for a multiplicity of ways to provide for the effects produced by way of the invention disclosed herein.

### BRIEF DESCRIPTONS OF THE SEVERAL VIEWS OF THE DRAWING

FIG. 1 This effect is made by first {1} having a source of content, video or film, live or from computer memory, that is connected to a projector and projected {2} onto a sculpted reflective surface {3} It reflects onto a screen or receiving surface {4}. This moving reflection is then recorded as a video or film {5}. This information is then exported and compiled {6} for a picture in picture type of pop up balloon or for stand alone usage.

[1] source live or memory

[2] projecting image

[3] CT Optic Distortion Filter comprised of a distorted optic, dynamic frame and negative spacing.

[4] that reflects onto a screen or receiving surface

[5] then recorded

[6] exported and compiled

FIG. 2 Construction of frame suitable to hold optics {1} a metal that keeps its shape or Flexible metal is fashioned into desired shape {2} threaded rod or any fastener is welded or attached to the frame {3} a wax reverse mold, for example, is created on the metal {4} resin is cast {5} jell or light diffusers filters added to cast parts.

{1} steel, copper, aluminum, or any metal

{2} threaded rod

{3} wax reverse mold

{4} cast resin

{5} jel for color

FIG. 3 Manufacture of optics is achieved by {1} cutting though material {2} heat source {3} optics are marked for holes, holes are made {4} heat raw optics in an environment that is safe to use heat, discharge heat to create desired effect {5} texture or patterns can be created {6} metal stamp is another option to create yet another effect.

{1} cut reflective material

{2} heat, laser, torch

{3}optics are marked for holes, holes are made

{4} apply heat

{5} add texture or patterns

{6} stamping

FIG. 4 Assembly of this invention is achieved by {1} join optics {2} to the frame {3} with negative spacing element {4} focus to screen for recording.

{1} optics

{2} frame

{3} negative

{4} focus

FIG. 5 1 color drawing, example of end result.

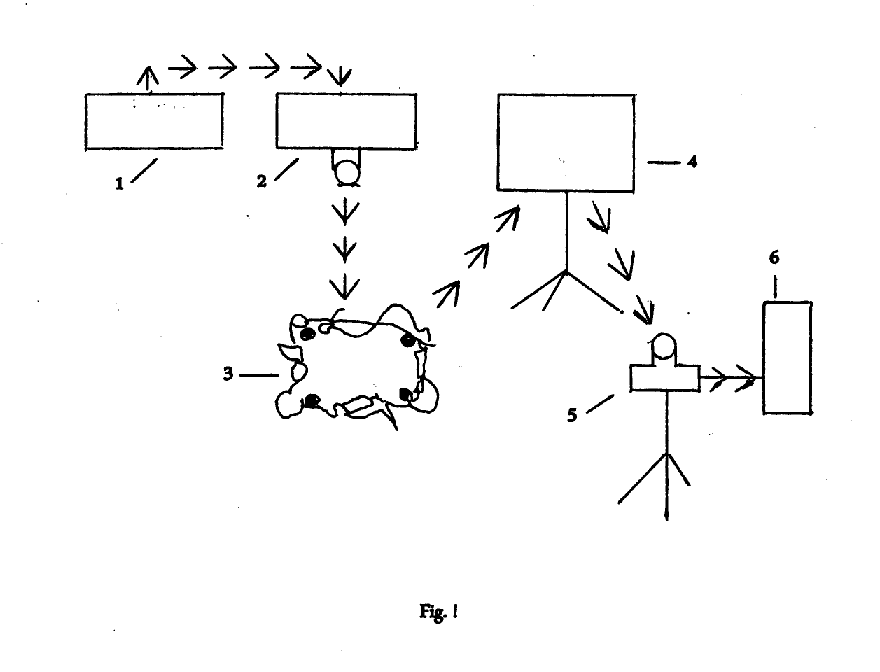

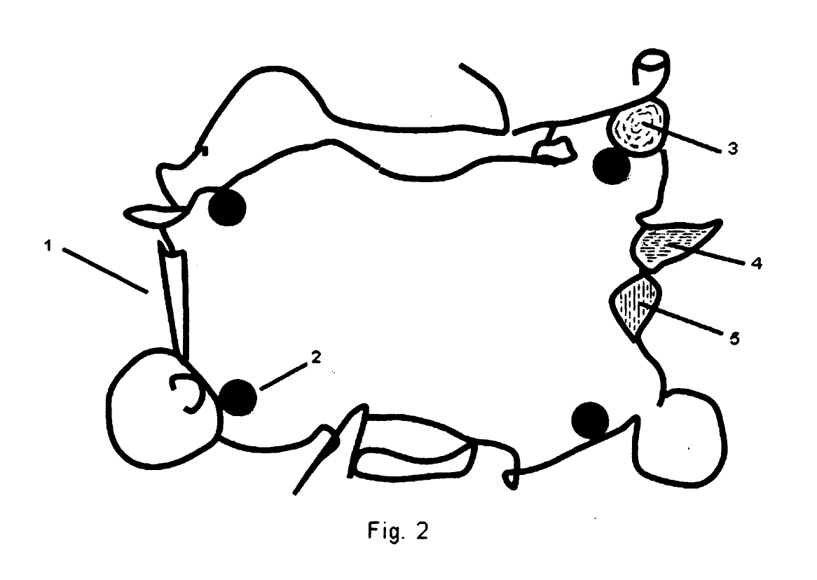

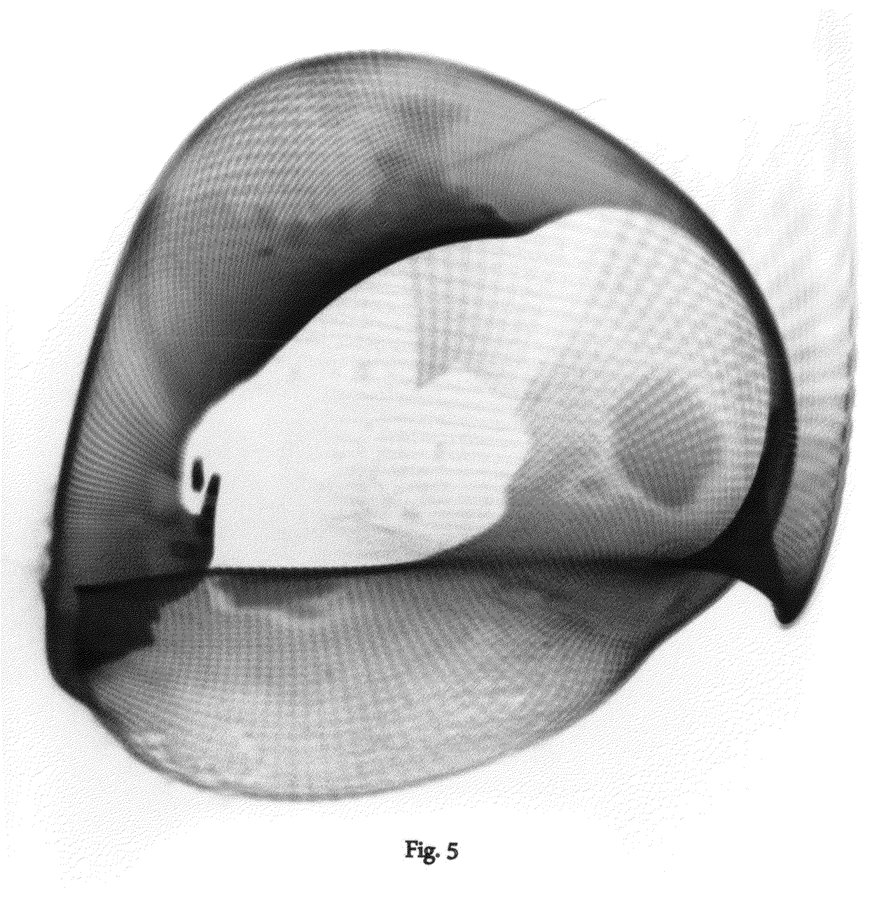

### BRIEF DESCRIPTION OF THE SEVERAL VIEWS OF THE DRAWINGS

[FIG. 1] This effect is made by first {1} having a source of content, video or film, live or from computer memory, that is connected to a projector and projected {2} onto a sculpted reflective surface {3} It reflects onto a screen or receiving surface {4}. This moving reflection is then recorded as a video or film {5} . This information is then exported and compiled {6} for a picture in picture type of pop up balloon or for stand alone usage.

[1] source live or memory

[2] projecting image

[3] CT Optic Distortion Filter comprised of a distorted optic, dynamic frame and negative spacing.

[4] that reflects onto a screen or receiving surface

[5] then recorded

[6] exported and compiled

[FIG. 2] Construction of frame suitable to hold optics {1} a metal that keeps its shape or Flexible metal is fashioned into desired shape {2} threaded rod or any fastener is welded or attached to the frame {3 } a wax reverse mold, for example, is created on the metal {4} resin is cast {5} jell or light diffusers filters added to cast parts.

{1} steel, copper, aluminum, or any metal

{2} threaded rod

{3} wax reverse mold

{4} cast resin

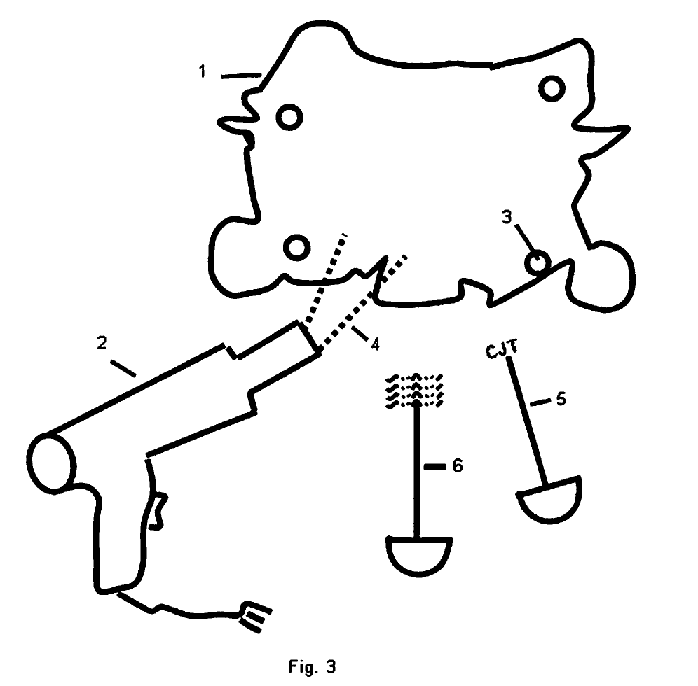

{5} jell for color

[FIG. 3] Manufacture of optics is achieved by {1} cutting though material {2} heat source {3} optics are marked for holes, holes are made {4} heat raw optics in an environment that is safe to use heat, discharge heat to create desired effect {5} texture or patterns can be created {6} metal stamp is another option to create yet another effect.

{1} cut reflective material

{2} heat, laser, torch

{3} optics are marked for holes, holes are made

{4} apply heat

{5} add texture or patterns

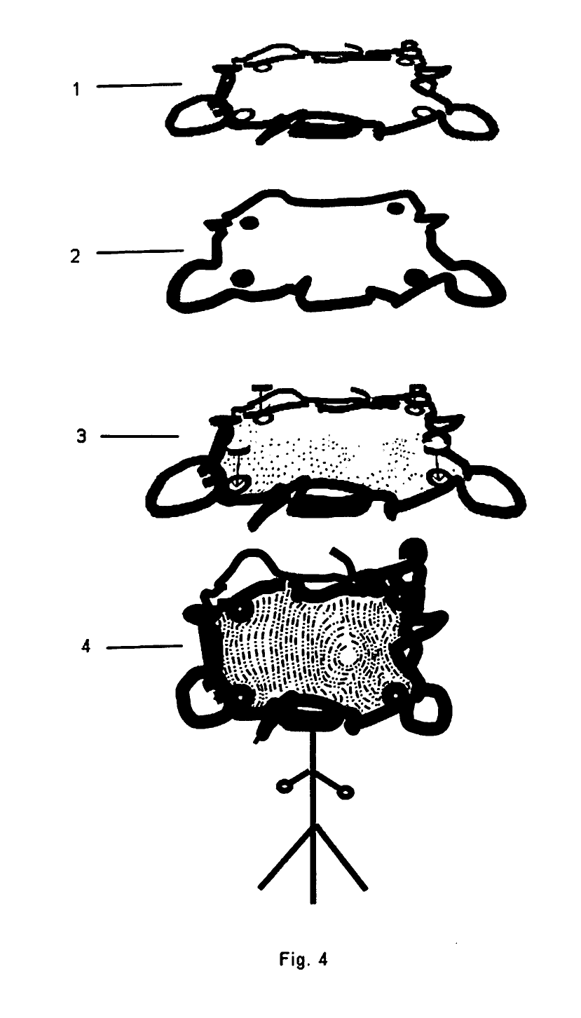

{6} stamping

[FIG. 4] Assembly of this invention is achieved by {1} join optics {2} to the frame {3} with negative spacing element {4} focus to screen for recording.

{1} optics

{2} frame

{3} negative

{4} focus

I claim:

1. A movable frame with an optically responsive surface disposed within the frame.
a. A movable frame with an optically responsive surface in the frame as described in claim 1, the optically responsive surface being reflective.
b. A movable frame with an optically responsive surface in the frame as described in claim 1, the optically responsive surface being refractive.
c. A movable frame with an optically responsive surface in the frame as described in claim 1, the optically responsive surface being translucent.
d. A movable frame with an optically responsive surface in the frame as described in claim 1, the optically responsive surface being irregularly shaped.

2. A movable frame with an optically responsive surface disposed within the frame.
a. A mechanically movable frame with an optically responsive surface disposed within the frame as described in claim 2, the mechanically movable frame being moved by mechanical means.

3. A frame having a movable optically responsive surface suspended within the frame.
a. A frame having a movable optically responsive surface suspended within the frame as described in claim 3, the movable optically responsive surface being moved by mechanical means.

4. A method of creating optical special effects wherein said special effects are recorded by recording images projected onto (a) a movable frame with (b) an optically responsive surface.

5. A method of creating optical special effects wherein said special effects are recorded by recording images projected onto (a) a frame with (b) a movable optically responsive surface.

6. A method of creating optical special effects comprising; a movable frame with a movable optically responsive surface within the frame, the movable optically responsive surface and the frame being movable by a plurality of motion generating means, the motion generating means being activated in such a way that at least one such motion activating means is a heat generating source, or a sound wave generating source or a wind generating source.

7. A method of creating optical special effects comprising;
A movable frame with an movable optically responsive surface within the frame, the movable optically responsive surface and the frame having a plurality of mechanical actuators, the mechanical actuators being activated and deactivated in such a way that at least one actuator is activated while at least one actuator is deactivated.
